(19) United States
(12) Patent Application Publication
(10) Pub. No.: US 2005/0243221 A1
(43) Pub. Date: Nov. 3, 2005

(54) Lens and CRT assembly and method of manufacture

(76) Inventors: Daniel G. Meiser, Butler, KY (US); David M. Snively, Cincinnati, OH (US)

Correspondence Address: 3M INNOVATIVE PROPERTIES COMPANY, PO BOX 33427, ST. PAUL, MN, 55133-3427, US

(21) Appl. No.: 10/838,094

(22) Filed: May 3, 2004

(51) Int. Cl. H04N 5/74

(52) U.S. Cl. 348/781

(57) ABSTRACT

A projection television lens and CRT assembly includes a lens mount with at least one optical lens element mounted therein and a focus mount connected to the lens mount. A CRT coupler is operatively coupled to the focus mount. A clamp plate and at least first and second spring plates are used to secure a CRT to the CRT coupler.

### FIELD OF INVENTION

The present invention relates generally to projection television sets and, more particularly, to the mounting system that couples a cathode ray tube (CRT) to the lens assembly which magnifies the image produced by the CRT for display on the screen of the projection television.

### BACKGROUND OF THE INVENTION

Projection television sets are a popular alternative to other types of television sets, as they provide a relatively large viewable area that cannot be efficiently produced using conventional picture tubes, and yet are less costly than other large screen systems. Rear projection television sets, which are generally more popular than front projection systems, typically include an enclosure for housing an optical assembly which comprises three CRT and lens assemblies for the respective primary colors red, green and blue, a mirror, and various other electronic components for receiving and projecting an image onto a screen mounted on the front of the enclosure.

In a typical projection television set, the magnifying lens assembly is coupled to its corresponding CRT using a CRT coupler or spacer which is positioned between a focus mount portion of the lens assembly and the CRT face plate, and a separate clamp plate which is placed in contact with a rear surface of the CRT. The front portion or face plate portion of the CRT is generally rectangular shaped and, therefore, the CRT coupler and clamp plate are correspondingly shaped. Four separate threaded fasteners, each having an associated compression coil spring, are secured at the respective corners of the generally rectangular shaped assembly to secure the assembly together. During the manufacturing process, the assembly must be aligned with the lens assembly, CRT coupler, CRT, and clamp plate in their proper positions, and then each of the four threaded fastener and spring assemblies must be secured in place and properly torqued to apply the necessary clamping force consistently at each of the four corners. A liquid coolant is typically introduced between the projection lens assembly and the CRT into a space surrounded by the CRT coupler or spacer, the CRT, and one of the projection lenses, which is typically a “C” lens carried by the coupler. The liquid coolant cools the face of the CRT by dissipating the heat radiating from the CRT and transferring it to the CRT coupler or spacer. The connections made between the CRT clamp plate and the CRT coupler must be adequate to properly and uniformly seal the liquid coolant space while maintaining proper alignment between the CRT face plate and the lens assembly.

The existing CRT and lens assembly constructions, however, have their disadvantages. Construction and assembly of the multiple components that make up the existing assemblies tend to be cumbersome and, thus, labor intensive. Also, the need for multiple fasteners and compression springs adds to parts inventory costs. Finally, the need to separately torque each of four fasteners may lead to variations in the forces applied at each corner of the assembly and, therefore, lead to potential sealing problems and/or non-uniform application of stress to the assembly.

### SUMMARY OF INVENTION

The present invention is directed to a projection television lens and CRT assembly which advantageously utilizes spring plates in place of conventional coil springs and threaded fasteners to couple the CRT to the lens assembly. In particular, the lens and CRT assembly of this invention includes a lens assembly. In the preferred embodiment, this lens assembly comprises a tubular lens mount having a longitudinal axis and at least a first optical lens element mounted therein along the longitudinal axis. The lens assembly also preferably comprises a tubular focus mount connected to the tubular lens mount and also extending along the longitudinal axis. A CRT coupler is operatively coupled to the lens assembly, for example, as a separate component or as an integral portion of the focus mount. A clamp plate secures a CRT to the CRT coupler using first and second spring plates in accordance with the invention. More specifically, the first and second spring plates each have first and second ends. The first ends are connected with the clamp plate and the second ends are connected with the CRT coupler to hold the CRT directly or indirectly against the CRT coupler with a spring force exerted by the first and second spring plates.

The first and second spring plates may be formed as completely separate components relative to the clamp plate and CRT coupler, or may be integrated into the clamp plate. In one specifically disclosed alternative embodiment, the first ends of the first and second spring plates are integrally formed with the clamp plate. In embodiments in which the spring plates are formed separately from the clamp plate, the first and second spring plates can include at least one clip on their first ends and the clamp plate can include a corresponding plurality of slots configured to receive and retain the clips. Likewise, the second ends of the first and second spring plates can include at least one clip configured to be retained on the CRT coupler. Preferably, the first and second spring plates are formed from hardened spring steel. The first and second spring plates each further comprise a curved plate structure generally having a first radius when disconnected from at least one of the CRT coupler or the clamp plate and a second, larger radius when connected between the CRT coupler and the clamp plate. This imparts a uniform tensile force sufficient to hold the CRT to the CRT coupler and effectively retain a coolant liquid in the space between a lens held by the CRT coupler, for example, and the face plate of the CRT.

A method of mounting a CRT to a lens assembly using a CRT coupler is also contemplated by this invention generally using components as discussed above. More particularly, the method includes aligning the CRT on a sealing surface adjacent the CRT coupler. A clamp plate is placed on a side of the CRT opposite the CRT coupler. In accordance with the invention, first and second spring plates are secured under tension between the clamp plate and the CRT coupler to hold the CRT to the CRT coupler and against the sealing surface.

The step of placing the first and second spring plates under tension can further comprise clipping the first and second spring plates to the CRT coupler and/or clipping the first and second spring plates to the clamp plate. The method preferably also includes mounting a lens to the CRT coupler, and filling a space between the lens and the CRT coupler with a coolant liquid. The spring plates are preferably curved plates and secured such that they become less curved upon securement between the CRT coupler and the clamp plate.

The invention further provides an assembly for coupling a CRT to a lens assembly of a projection television. In particular, this assembly includes a CRT coupler adapted to be fixed to the lens assembly, a clamp plate, and first and second spring plates. The first and second spring plates each have first and second ends. The first ends are connected with the clamp plate and the second ends are connected with the CRT coupler and are configured to hold the CRT against the CRT coupler with a spring force exerted by the first and second spring plates.

The invention provides an apparatus and method which not only reduce the number of components in a CRT and lens assembly for a projection television, but also helps ensure that the forces applied between the CRT coupler and the CRT clamp plate are more consistent or uniform both in regard to a particular CRT and lens assembly and from one CRT and lens assembly to another. This is due to the fact that four separate threaded fasteners do not have to be separately torqued down for each assembly and, therefore, the potential for inadequately applied torque or over-torqued fasteners is eliminated. Moreover, the use of spring plates helps ensure that more uniform force is applied to the seal between the CRT coupler and the clamp plate thereby lessening the chances for liquid coolant leakage.

### BRIEF DESCRIPTION OF THE DRAWINGS

FIG. 1 illustrates a perspective view of a CRT and lens assembly constructed in accordance with a first embodiment of the invention.

FIG. 2 is an exploded perspective view of the embodiment shown in FIG. 1.

FIG. 3 is a top view of the embodiment illustrated in FIG. 1.

FIG. 4 is a perspective view of a CRT and lens assembly constructed in accordance with a second embodiment of the invention.

FIG. 5 is an exploded perspective view of the embodiment shown in FIG. 4.

FIG. 6 is a top view of the embodiment shown in FIG. 4.

### DETAILED DESCRIPTION

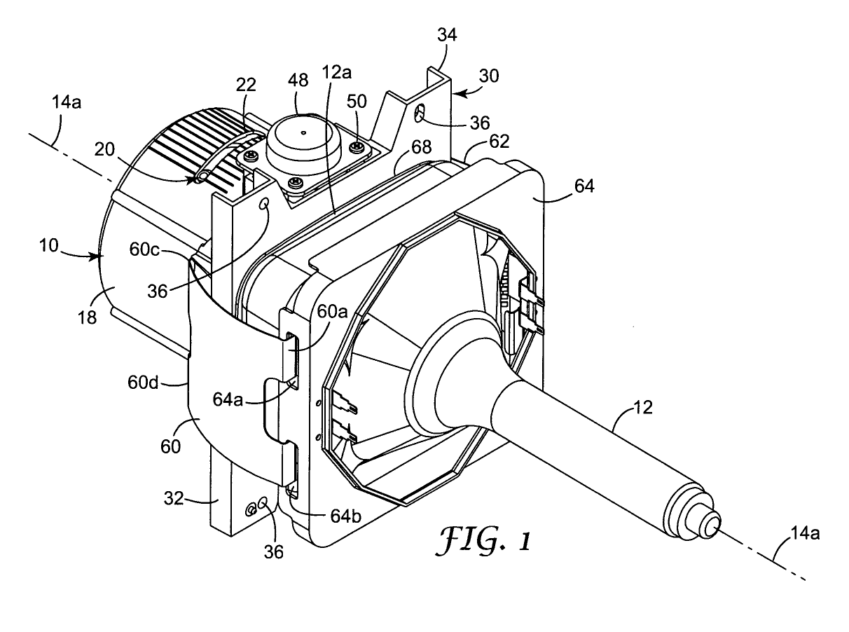

FIGS. 1-3 illustrate a first embodiment of the invention. Specifically, a lens assembly 10 is connected to a CRT 12 and includes a tubular lens mount 14 having a longitudinal axis 14a and at least a first optical lens element (not shown) mounted therein along the longitudinal axis 14a. In this embodiment, multiple lens elements may be mounted within the tubular lens mount and may comprise separate “A” and “B” lens elements as are conventionally used in projection television lens systems. A more complete description of a suitable lens assembly 10 may be found, for example, in U.S. Ser. No. 10/665,950, filed Sep. 19, 2003, assigned to the assignee of the present invention and the disclosure of which is hereby fully incorporated by reference herein. Additional representative lens assembly configurations which may be used in conjunction with the present invention are formed in U.S. Pat. Nos. 6,285,416; 6,441,976; and 6,600,612, the disclosures of which are hereby incorporated by reference herein. The tubular lens mount 14 is mounted within a tubular focus mount 18 extending along the same longitudinal axis 14a and adjustable fastening and locking structure 20 connects the lens mount 14 to the focus mount 18 allowing a focus position to be obtained and locked in place between the lens mount 14 and the focus mount 18. This fastening and locking structure 20 may comprise a slot 22 in the focus mount 18 and conventional threaded fastening and clamping elements (not shown) coupled with the lens mount 14 in a known manner. Because the slot 22 is angled transversely to the longitudinal axis 14a, rotation of the lens mount 14 relative to the focus mount 18 will change the longitudinal position of the lens mount 14 and the focus mount 18 relative to each other along the longitudinal axis 14a. This changes the focus of the lens system 10 by changing the distance of the optical lens elements in the lens mount 14 relative to the CRT 12. In the presently preferred embodiments, a CRT coupler 30 is formed integrally with the focus mount 18 and includes flanges 32, 34, slots (not shown), or other appropriate fastening structure for securing the CRT 12 thereto in a manner to be described below. Projection television fastening structure (e.g., holes 36) are also provided for securing the CRT coupler 30 to the mounting structure within the projection television cabinet (not shown). It will be appreciated that the CRT coupler 30 may instead be formed as a separate component from the focus mount 18.

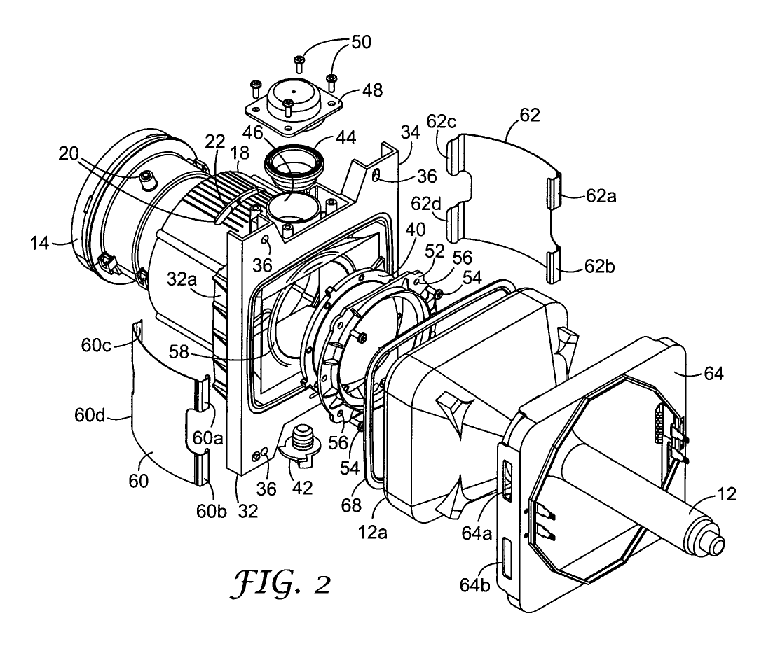

As best shown in FIG. 2, coolant fluid may be introduced through an opening (not shown) in the CRT coupler 30 into a space defined by the coupler 30 itself and located between a “C” lens element 40 and the CRT face plate 12a. A plug 42 is provided to seal the liquid coolant fill hole. An expansion bladder 44 is introduced into an opening 46 of the coupler 30 and is covered by a cover plate 48 secured with fasteners 50 to allow for expansion of the liquid coolant when heated by the CRT 12. The “C” lens element 40 is secured in place by a clamp plate 52 with screws 54 extending through holes 56 in the clamp plate 52 and aligned holes (not shown) in the coupler 30. This creates a sealing relation between the “C” lens element 40 and the coupler 30 by compressing, for example, an O-ring seal (not shown) against an annular surface 58 of the coupler 30 or the focus mount 18.

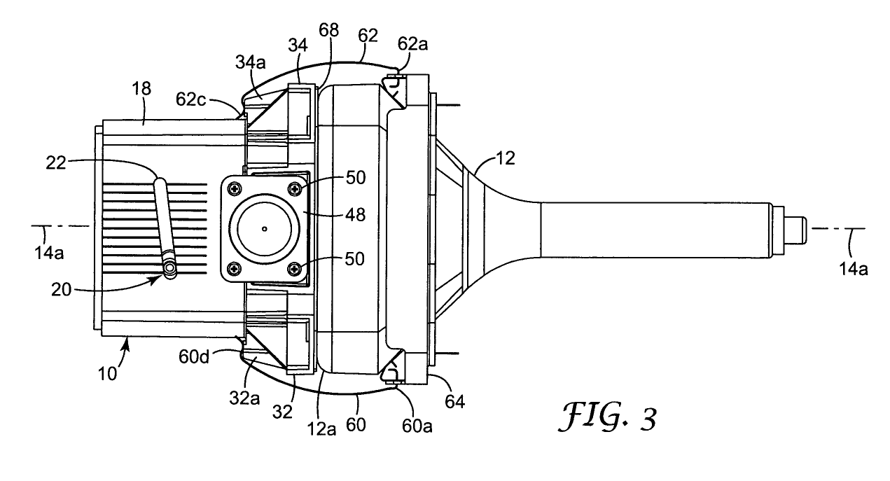

Still referring to FIGS. 1-3, and in accordance with the invention, a pair of spring plates 60, 62 preferably formed from hardened spring steel are connected between a CRT clamp plate 64 and opposite side flange portions 32a, 34a of the coupler 30. In this specific embodiment, spring plates 60, 62 span substantially the entire height of the CRT 12, as best viewed in FIG. 1, and include pairs of respective clips 60a-d, 62a-d on opposite ends thereof. First and second clips 60a, 60b, 62a, 62b are received and retained by respective slots 64a, 64b in the CRT clamp plate 64 (only one side shown). The clips 60c, 60d, 62c, 62d on the opposite ends of each spring plate 60, 62 may be clipped around the edge of the associated flange portion 32a, 34a of the coupler 30, as shown best in FIG. 3, or retained on coupler 30 in similar slots as formed in the clamp plate 64, or by other methods. The method illustrated in this embodiment is advantageous because a simple fixture may be used to push the clamp plate 64 and associated spring plates 60, 62 down onto the remainder of the assembly whereupon the second ends 60c, 60d, 62c, 62d of each spring plate 60, 62 will snap into place behind the respective flange portions 32a, 34a as shown in FIG. 3. It will also be appreciated that the spring plates 60, 62 will have a slightly larger radius of curvature when secured in place, as shown in FIG. 3, as compared to their normal radius of curvature when not placed under load, as shown in FIG. 2. Thus, in FIG. 3, spring plates 60, 62 are placed under tension and thereby hold the assembly 10, 12 together as shown with a uniformly applied force transferred from the clamp plate 64 onto the CRT 12 and finally onto a seal 68 and coupler 30 to thereby seal the space between coupler 30, “C” lens element 40 and CRT face plate 12a.

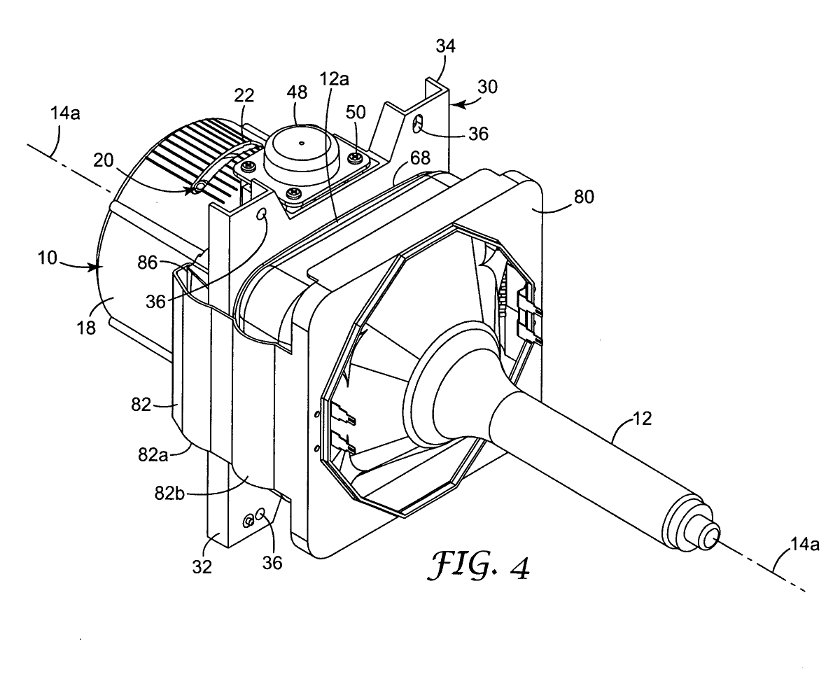

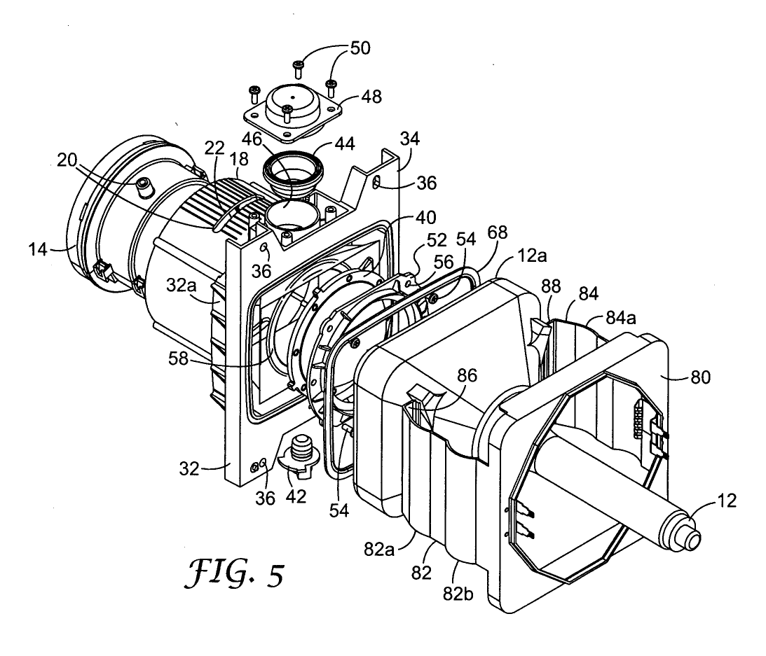

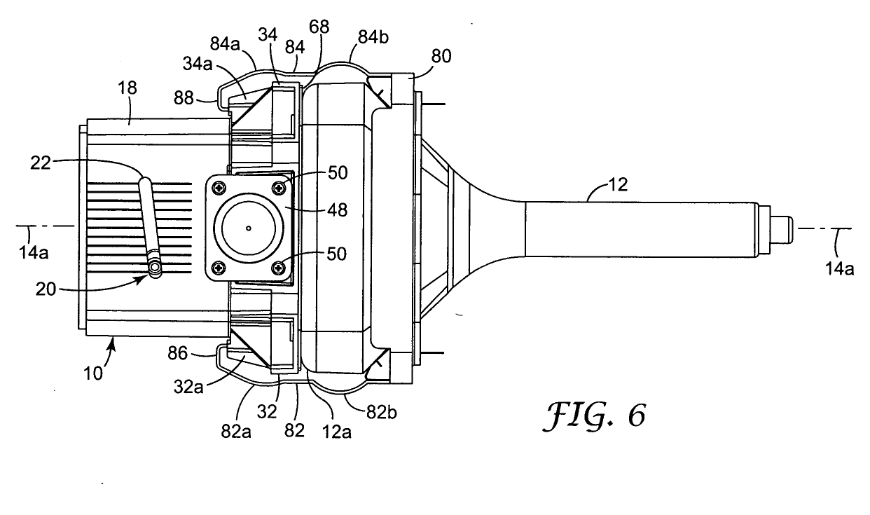

FIGS. 4-6 illustrate a second embodiment of the invention in which like numerals refer to like elements of structure in the first embodiment. As such, such like components between the first and second embodiments will not be again described in detail with respect to the second embodiment. The main difference between this second embodiment and the first embodiment is that the two spring plates have been integrated into the clamp plate associated with the CRT 12. Thus, the clamp plate 80 in this second embodiment includes two spring plates 82, 84 which again clip behind respective opposite side flange portions 32a, 34a of the coupler 30 (as shown best in FIGS. 4 and 6) through the use of clips 86, 88. Like the first embodiment, these spring plates 82, 84 may have one or more radiused sections 82a, 82b, 84a, 84b which become slightly extended so as to have a larger radius of curvature when under load in the connected positions as shown in FIGS. 4 and 6. This directs a tensile clamping force again generally between the CRT clamp plate 80 and the coupler 30 thereby holding the CRT face plate 12a against the seal 68 associated with the CRT coupler 30 or the focus mount 18 depending on the particular design of the lens assembly 10. In this second embodiment, the entire clamp plate 80 and integrally formed spring plates 82, 84 may be formed from hardened spring steel.

Those of ordinary skill in the art will understand, upon review of the foregoing that the various aspects of this invention can lead to reduced manufacturing costs, easier lens and CRT assembly procedures, and more reliable and effective securement of the CRT to the lens assembly. While the present invention has been illustrated by a description of preferred embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims, wherein

1. A projection television lens and CRT assembly comprising:
a lens assembly;
a CRT coupler operatively coupled to said lens assembly;
a CRT;
a clamp plate;
first and second spring plates each having first and second ends, said first ends connected with said clamp plate and said second ends connected with said CRT coupler to hold said CRT against said CRT coupler with a spring force exerted by said first and second spring plates.

2. The projection television lens and CRT assembly of claim 1, wherein said first ends of said first and second spring plates are integrally formed with said clamp plate.

3. The projection television lens and CRT assembly of claim 1, wherein said first and second spring plates are formed separately from said clamp plate.

4. The projection television lens and CRT assembly of claim 3, wherein said first and second spring plates include a plurality of clips on said first end and said clamp plate includes a plurality of slots configured to receive and retain said clips.

5. The projection television lens and CRT assembly of claim 1, wherein said second ends of said first and second spring plates include at least one clip configured to be retained on said CRT coupler.

6. The projection television lens and CRT assembly of claim 1, wherein said first and second spring plates are formed from hardened spring steel.

7. The projection television lens and CRT assembly of claim 1, further comprising:
a seal positioned between said CRT and said CRT coupler;
a second lens mounted to said CRT coupler; and
a coolant liquid contained in a space between said CRT and said second lens.

8. The projection television and CRT assembly of claim 1, wherein said first and second spring plates each further comprise a curved plate structure generally having a first radius when disconnected from at least one of said CRT coupler or said clamp plate and a second, larger radius when connected between said CRT coupler and said clamp plate.

9. The projection television and CRT assembly of claim 1, wherein said lens assembly further comprises:
a tubular lens mount having a longitudinal axis and at least a first optical lens element mounted therein along said longitudinal axis, and
a tubular focus mount connected to said tubular lens mount and extending along said longitudinal axis.

10. A method of mounting a CRT to a lens assembly using a CRT coupler, a clamp plate and first and second spring plates, the method comprising:
aligning the CRT on a sealing surface adjacent the CRT coupler;
placing the clamp plate on a side of the CRT opposite the CRT coupler; and
placing the first and second spring plates under tension between the clamp plate and the CRT coupler to secure the CRT to the CRT coupler and against the sealing surface.

11. The method of claim 10, wherein the step of placing the first and second spring plates under tension further comprises:
clipping the first and second spring plates to the CRT coupler.

12. The method of claim 10, wherein the step of placing the first and second spring plates under tension further comprises:
clipping the first and second spring plates to the clamp plate.

13. The method of claim 10, wherein the step of placing the first and second spring plates under tension further comprises:
clipping the first and second spring plates to the clamp plate.

14. The method of claim 10, further comprising:
mounting a lens to the CRT coupler; and
filling a space between the lens and the CRT coupler with a coolant liquid.

15. An assembly for coupling a CRT to a lens assembly of a projection television, comprising:
a CRT coupler adapted to be fixed to the lens assembly;
a clamp plate; and
first and second spring plates each having first and second ends, said first ends connected with said clamp plate and said second ends connected with said CRT coupler and configured to hold the CRT against said CRT coupler with a spring force exerted by said first and second spring plates.

16. The assembly of claim 15, wherein said first ends of said first and second spring plates are integrally formed with said clamp plate.

17. The assembly of claim 15, wherein said first and second spring plates are formed separately from said clamp plate.

18. The assembly of claim 17, wherein said first and second spring plates include a plurality of clips on said first end and said clamp plate includes a plurality of slots configured to receive and retain said clips.

19. The assembly of claim 15, wherein said second ends of said first and second spring plates include at least one clip configured to be retained on said CRT coupler.
